(19) United States
(12) Patent Application Publication
(10) Pub. No.: US 2014/0365343 A1
(43) Pub. Date: Dec. 11, 2014

(54) Method for Expediting Retail Pricing, Product Location, and Label Printing for Inventory

(71) Applicant: Patrick Andrew Joseph Peters, Edgewater, MD (US)

(72) Inventor: Patrick Andrew Joseph Peters, Edgewater, MD (US)

(21) Appl. No.: 13/915,310

(22) Filed: Jun. 11, 2013

(51) Int. Cl. G06Q 10/08; G06F 3/0481

(52) U.S. Cl. CPC G06Q 10/087; G06F 3/0481
USPC 705/28

(57) ABSTRACT

A computer implemented method and process for expediting the retail pricing and re-pricing procedure within a retail inventory system database is described. The process associates the retail data with product location information as dictated by product location design sheets as well as pre-established pricing structures, and distributes the data and data entry work performed by an individual at one retail location to all other accompanying retail locations. In this manner, labor and money are saved as work conventionally performed by a series of individuals located at separate store locations is instead performed by a single individual at a central location and distributed to all other locations in the series.

### CONTINUITY DATA

This is a non-provisional application claiming priority to provisional patent application No. 61/689,743 filed on Jun. 11, 2012.

### FIELD OF THE PRESENT INVENTION

The present invention relates to process of retail pricing, and more specifically, those processes designed to assign and reassign pricing, production location data, and product information to barcoded numerals conventionally placed on products and shelving for products within a standard retail environment.

### BACKGROUND OF THE PRESENT INVENTION

In retail environments, maintaining accurate pricing and inventory count on products is critical to ensuring smooth and accurate database management. Conventionally, barcodes are used to expedite the process of associating identification numbers on products to corresponding identification numbers in retail inventory databases. Similarly, retail environments, especially members of store franchises, spend resources on business marketing which includes the deliberate planning of the ordering and display of each product. Planned displays such as these are created with software and are frequently distributed to each store to ensure consistency. End-cap planning is often designed to be context sensitive to the season or a particular store special. At certain times, products are often reduced in price; therefore, the price attributed to the product both on the store shelf and within the Point of Sale terminal database and/or the inventory database of the store must be changed accordingly. Traditionally, this has been done manually via data entry.

In a retail situation with many locations or franchises, each location must individually enter current pricing information. The pricing information conventionally correlates to product identification codes (UPCs, etc.), which is then associated with the location of the product on the shelf according to the shelf price, as well as to the inventory database of the retail location. This task conventionally requires an employee at each location to input new pricing information when it is updated. Usually, this is performed weekly, depending on the retail chain. As each location must do this separately, a separate employee at each location usually performs the work, which is identical to the work of other employees at other store locations changing the pricing. If there were an easy and effective way for a single individual to perform this work, and then distribute the pricing changes concurrently to all other locations, a large amount of labor and cost to the company can be saved. Even more savings could be accomplished if the retail chain intends to modify pricing information more than once a week.

Thus, there is a need for a way to simplify and expedite the pricing and location information changes which occur weekly, such that the labor may be adequately performed by a single individual at a single location and then the changes and information distributed to all other chain locations. This is in contrast to multiple individuals performing the same task at a variety of locations.

European Patent number EP0707354B1, filed on Dec. 12, 1995 by Guzak et al. is for a Data Transfer With Expanded Clipboard Formats. Guzak et al. teaches a computer system having a clipboard for performing data transfer in a clipboard format. Guzak et al. provides the framework for the copy/paste clipboard functionality employed by the present invention. However, the present invention adapts this functionality and enhances it beyond merely transferring ASCII text. The present invention differs from Guzak et al. in that the present invention is a system which employs, in part, the Microsoft Clipboard, yet after use of this feature, the present invention employs a formula to expedite the re-pricing process of inventory and mapping items to shelf locations via unique identification codes.

### SUMMARY OF THE PRESENT INVENTION

The present invention is a system and method for the facilitation of data entry processes relating to the scheduled retail pricing changes of inventory within a retail store's computer system and inventory database. The present invention employs a conventional Business Solution Software (BSS) when interfaced with the Microsoft Text Box provides for the use of the copy, paste, and clipboard functions within a non-native program architecture. The present invention accomplishes this by instructing the computer to execute a script or plug-in that provides for the BSS to interface with the Microsoft Text Box, enabling initial time to be saved during the process of data entry, and providing for the efficient dissemination of the pricing and product location information to all associated retail locations within the network.

Any Retail Business using the CT2020 Store System or a similar BSS software solution with multiple facilities which uses identical product planners for preplanned displays to produce Point of Sale Signage or Tickets can reduce time and labor costs of individual input data. This is currently performed by one employee at each facility. After the PRK formula of the present invention is applied, the work of one person is universally applied and distributed among all using that particular program/network. It will no longer be necessary for each entity to re-enter the data per location.

Business mandatory display bulletins are mapped plans distributed to retail facilities to execute on predetermined locations within each facility. Any UPC corresponding product location, such as end caps, shelf kiosks, and special display locations are considered planned mandatory displays. In addition, within the aisles themselves is a planned location of merchandise that different companies such as Campbell's Soup© or Post© cereal pay to have a prime or special location within the store, as well as within the shelves of the store.

Some businesses may have all their outlets identical, where as others may have none that are planned in the same way. The best or most effective use of the present invention would be in a larger business that has an identical store model used in its facilities, and the scope of the application would encompass all businesses under the umbrella of the franchise or chain.

New items are another category that retailers sell to companies. Companies attempt to develop and market these products to attract and identify additional market sales within the brand name of the companies. These ‘new’ competitive commodity items are then rushed to market within the retail outlets, integrated within the shelf location design sheets. Each facility has location indicated for these design sheets. Commonly, the front page of a weekly sale advertisement would be determined by the best public position on commodity purchases and company profit or any and all parts of that final result.

Retailers plan and purchase inventory ahead of time, sometimes weeks ahead of time, and produce multiple display plans for these items within a determined time frame. All of these processes factor into a mass strategy to promote all aspects of a viable business practice. The display planners are then distributed to the retailers facilities for preparation of the advertisement. There is labor to order, build, and mark these displays with the correct sequence in order to make the plan work, and to present the consumer with the sale items when the retail plan is executed.

### BRIEF DESCRIPTION OF THE DRAWINGS

FIG. 1 shows a flow chart detailing the process of the present invention.

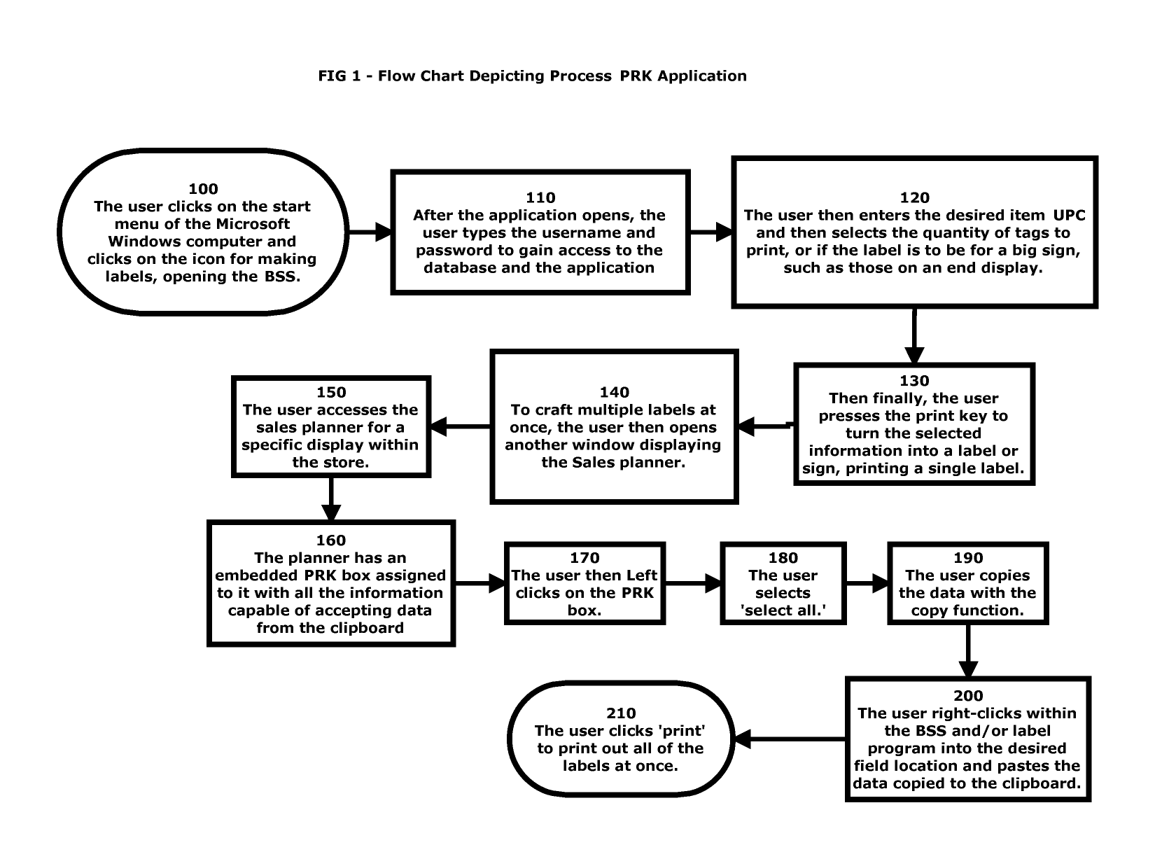

### DETAILED DESCRIPTION OF THE PREFERRED EMBODIMENT

The present invention is a method and process, carried out via a computer (10), which interfaces a basic business solutions software (BSS) with features and solutions provided by a modified or augmented version of Microsoft Word. More specifically, the preferred embodiment of the present invention employs a Microsoft Word Text Box (MTB) protocols and source code containing the Unique Linear Numeric Sequence (UNLS) of PRK which is then embedded within a Business Solutions Software (BSS).

Essentially, the present invention is a software augmentation or addition, such as a plug-in or script, which provides for the facilitation of efficient data entry into a retail system, such as those based on barcodes and maintained with an inventory database. The script of the present invention utilizes the Microsoft Word Textbox architecture to hold the PRK Unique Linear Numeric Sequence which can then be imbedded as an entirety into a Business Solutions Software. It should be understood that the end result and key benefit of using the process of the present invention, the Product Replication Key formula and application is to save large corporations time and money. Rather than one employee at each retail location individually performing weekly pricing updates, product location changes, and shelf-price-barcode mapping, adding up to 100 employees if there are 100 retail locations, the present invention enables one central employee to perform the work and distribute it effectively to all retail locations (via a computer). This works best when all retail locations within the group have a similar store layout and structure.

The system of the present invention combines a Word Document Text Box containing a unique numeric linear sequence developed by the inventor which, when embedded into the BSS, creates a new dynamically enhanced data entry sequence for the BSS. Information thus encoded into the Microsoft Textbox by an individual, once created within the BSS, can then be distributed throughout all computers utilizing the same BSS software within the network of retail stores.

The critical portion of the present invention is the PRK is the Unique Linear Designated Information (ULDI) or The Formula, imbedded in a text box which, when transferred/pasted into a Business Solutions Software allows that software to execute the commands conveyed by the Formula.).

Merchandise End Cap Displays (MECD) Explained as implemented by PRK.
Example of MECD:
   MECD-Merchandising
   End Cap Display W/PRK inserted.

Category Locator

| | | |
|---|---|---|
| Store xxxx | Week xx | Find |

Below are design planner links indicating store divisions and weeks. Click on the individual link to view it. Copy and Paste PRK data to BSS. Enclosed PRK data was repeated for example purpose only. PRK data will correspond with MECD requirements.

Below, is an itemized breakdown of the first line of the Planner as is conventionally viewed by the employee planning inventory locations at the headquarters of the company, and is utilized by the employee conducting the price changing process.

Floor indicates category of planner location.

[✓] Floor

Subheadings, such those shown below, are links to business planners.

[✓] AisleStacks BabyTissueTowel (4×4)

Example: Of Opened Link

AisleStacks BabyTissueTowel (4×4)

| | | |
|---|---|---|
| 1700089123 | Baby aisle | (2 large signs inferred) |
| 1700089124 | Tissue aisle | (2 large signs inferred) |
| 1700089125 | Towel aisle | (2 large signs inferred) |

This example requires 2 large signs per UPC.

(This example shows that 2 large signs needed to accompany the UPC)

Each of these Signs are to be placed as indicated in the Subheading of the field.

The UPC is then entered into the PRK Numeric Linear Designated Information.

Below is a group of the PRK which produces 2 large signs for each UPC.

The numeric linear sequence is shown for each PRK textbox separately.

Each Link opens a task/design to be carried out in a particular location for that week. These tasks are identified by UPCs.

Task/design may include multiple UPC's limited only exclusively to the UPCs product dimensions placed within a predetermined end cap with designated shelf dimension.

Example of New Information With PRK Text Box Added

The expanded text boxes (below)* show the coded information contained within each link above:

The Weekly MECD/PRK platform is conventionally provided by Headquarters of the retail company or chain.

Combined PRK Example:

The example below demonstrates PRK's exponential flexibility.

The BSS will accept all MECD/PRK data combined in numeric linear sequence. The limit of this capacity has not been tested. However the BSS will limit the amount of data to be pasted probably to protect itself from crashing. PRK formula employed below shows the Sequential Numeric Sequence the BSS will recognize to accept all data. (PRK below shows the Sequential Linear Numeric Sequence the BSS is able to recognize and uses to execute all data.)

Link Combined (With PRK)—

PRK Text Box Expanded

MECD example shows multiple links within category.

Each link has an adjacent PRK with corresponding data and structure that will produce planner label and the sign inferred.

End of Example

The PRK Business method formula or equation is applied by the script or program of the present invention, and the process can be outlined as follows:

The PRK formula when applied within the script or program by means of the Unique linear numeric sequence (ULNS) demonstrates PRK efficiency with Corporate Jargon. Letters A thru D below each represent a step in the retail process to produce and apply pricing updates to business planners. Whereas A+B+C+D equal the combination of steps in this process, each of these steps is part or equal to a percentage of combined steps to a completed task. However, it should be understood, that in the preferred embodiment of the present invention, language such as A+B+C+D etc. are not formulas for PRK, but the algebraic language is being used in this application to convey the present invention in the context of corporate jargon used in a retail situation. It should be understood that, in the preferred embodiment, all steps of the present invention are performed by a computer.

A+B+C+D=completed price change and/or label printing task.

The Letter E equals the combination of step A thru D in a percentage result to application.

Although completion to 100% of the task is the goal this combination may not equal 100%.

A+B+C+D=E

PRK enables the time used in steps B and C to be minimized.

The diminished time used in steps B and C are less than (<) the Current Method Time (CMT).

ACMT+(B<CMTB)+(C<CMTC)+DCMT<ACMT+BCMT+CCMT+DCMT

The proportionate time within Steps B and C is shifted to Step D increasing the % of total time used in the CMTD to be applied to the Physical aspect value D where A is a constant.

A+(B<CMTB)+(C<CMTC)+(D>CMTD)

The Second formula aspect coinciding with the first whereas the first being the amount of time used to completion of the business task and the second being the success rate to corporate goals.

The following values apply:

E=Allowed time

F=percentage of planners labeled + or − allowed time frame G=Completed % of task vs. allowed labor cost.

In the current method B, C and D represent the greatest % of time.

A+(B=>CMT %)+(C=>CMT %)+(D=>CMT %)

Step A is a constant where the employee collects Data from corporate that requires the opening and printing of files used for data entry and the organization of such to reflect the mapped facility.

Step B is the reference of these planners by the employee where the employee must disseminate the required data to be applied.

Step C is the keying in of UPC data and printing whereas the keying in of data requires a time % of C as does the printing.

Step D is the physical placing of labels and signs on the sales floor.

The time allotment below is envisioned to be for an 8 hour shift. These values applied to the current and new formula represent the redirected time allocated to complete task.

Current time allocation to each step

A=10%=48 min

B=10%=48 min

C=40%=3 hours 12 min

D=40%=3 hours 12 min

A+B+C+D=E

10%+10%+40%=40%=100% time allowed

48 min+48 min+192 min+192 min=480 min or 8 hours. Current practice limits D physical application to the shelf.

The following is the PRK (Shifted) time allocation to each step:

A=10%=48 min 5%=24 min

B=5%=24 min

C=10%=48 min

D=75%=6 hours

A+(B<CMTB)+(C<CMTC)+(D>CMTD)

10%+5%+10%+75%=100% time allowed

This restructured allocation of time for each task provides a greater than the current method % of time to apply physical labels to shelf.

A=Employee collected UPC data required to make labels by printing business planners

B=Business facility weekly planners organized and mapped for labels and Sign locations

PRK=paste PRK text box onto business solution software (BSS)/prints.

D=Physical application onto actual facility shelf location of planned displays.

E=completed percentage of planners labeled + or − allowed time frame

F=Allowed Time

G=Completed % of task vs allowed labor cost

The following is the preferred embodiment of the PRK method formula employed by the present invention:

In the PRK method ‘B+t’ or B, time used is diminished or removed as the Business planners now have the data with an embedded PRK text box. C is replaced with PRK and the time is diminished with a unique numeric sequence imbedded on planners are pasted into the BBS although the Printing process time remains. The total allowed time is then shifted to task D the physical placement of labels and Signs.

### EXAMPLE

An employer allows 8 hours to complete task (F). The Employee completes 100% of task (E) with time remaining This identifies time/cost savings. The Business was able to report task completed 100% in all facilities. As a result of the use of this formula within the program or script of the present invention, any retail business that utilizes the ct2020 store system to produce point of sale signage and product information labels can format a time determined display outline that includes all predetermined UPC and or corporate code items along with their respective positions on displays that determine the type of Point-of-Sale required by a retail business in similar store designs. As such, not only is the time spent on data entry drastically reduced, but the time spent disseminating and creating point of sale signage, barcode labels, as well as product location design sheets is reduced as well.

Theoretically symbols by themselves or (symbols intermingled with numbers) can compose the formula.

Identifying the values on the Word document:

The BSS will execute Valued Command Lines (VCL) of a word document. Each character space of a word document has a value to the BSS. In order for the present invention to function, it is necessary for the BSS program to recognize a particular sequence of symbols/numbers/ (or combination thereof) thus allowing BSS to recognize the formula. The combined text box data (PRK) when copied will enable the BSS.

Additionally, the BSS can be modified to recognize additional values to word symbols, as well as Combination of symbols and numbers. It should be noted that CT2020 is to be understood as any Microsoft compatible business solution software (BSS). Any reference to CT2020 is merely the software where the PRK process of the present invention was tested. It is envisioned that the present invention may be configured to function with a wide assortment of business solution software applications.

Currently, within conventional BSS applications, labels, shipping, pricing information, etc. are generated via manual entry for each individual UPC held in backroom inventories. The labels are placed on the corresponding shipping box to streamline interface totals with the handheld device for the purpose of tracking back room inventories. With the system of the present invention, UPC lists of backroom inventory converted to the Product Replication Key format via the PRK formula will replace manually requested labels from handheld scanners to streamline record keeping of backroom inventories across all retail locations. The use of the present invention in this embodiment could be expedited in the event that the BSS employed provides an extension of its attributes to a hand held scanner device, capable of reading barcodes with a laser. The hand held scanner device enables the user to interface with the BSS when in a remote location via a wireless network system. Given that attention to back room inventory in a retail environment can be critical to the success of the business, the present invention facilitates back room inventory upkeep in that the printing of labels for products is expedited, given that the item information is copied or ported from the text box to the BSS application. Presently, the BSS application provides a vehicle through hand held scanning devices that managers use to track backroom inventory easily. Additional labor is required by Managers as they must scan product that is enclosed in packaging or key in UPC data from outside containers. With the present invention, UPC lists of backroom inventory will be generated via the PRK, streamlining backroom inventory tracking.

In summary, the process of the present invention is preferably employed by an employee of the retail company in the following general manner:

First, the user clicks on the start menu of the Microsoft Windows computer and clicks on the icon for making labels (100). This application is referred to as the BSS. After the application opens, the user types the username and password to gain access to the database and the application (110). The user then enters the desired item UPC and then selects the quantity of tags to print, or if the label is to be for a big sign, such as those on an end display (120). Then finally, the user presses the print key to turn the selected information into a label or sign (130). This is the process for making a single label. To make additional labels while employing the present invention, additional steps are required.

To craft multiple labels at once, the user then opens another window displaying the Sales planner (140). The user accesses the sales planner for a specific display within the store (150). The planner has an embedded PRK box assigned to it with all the information capable of accepting data from the clipboard (160). The user then Left clicks on the PRK box (170). The user selects ‘select all’ (180). The user copies the data with the copy function (190). The user right-clicks within the BSS and/or label program into the desired field location and pastes the data copied to the clipboard (200). The data is populated according to field location, character limits, character types established by the database, and other limiting factors. The user clicks ‘print’ to print out all of the labels at once. (210). It is envisioned that the PRK can hold effectively infinite quantities of numbers to be copied or ported to the label making program in the correct format.

In retail environments, sales planners are generated in advance and are based on the UPCs of each inventory item. Supply warehouse categories are not generally identified via the UPC, but may be mapped to the inventory via a relational database. Timely ordering is required to allow the product to arrive prior to advertisement day, in order to be placed on sale display and shelving for consumers. In this manner, the BSS may be modified to produce advanced dated tags and signs, which can further enhance the efficacy of the PRK of the present invention.

Additionally, the system of the present invention may be used as an assistance tool for store managers. PRK printing of all UPC data to labels provides a tool in advance for managers to identify warehouse profiles and capture ordering transmission schedules for facilities to assure produce availability. The information on the labels conventionally contains warehouse designation and location information. Additionally, weekly labels for new advertising profile printed on paper give managers a visual aide. This aide provides warehouse designated location/quantity pack size/dated effective pricing of each UPC.

A weekly PRK/BSS printout of all advertisement labels can also identify early invalid codes allowing time for managers to identify alternate or correct information.

In theory BSS can be modified to have advertisement day data (Advanced Date/Time format ADTF) available to managers prior to BSS updates to facility real-time data files. As a result of this application, retail business would have restructure options to current preparation and execution of advertisement day to the public.

File pricing Clerks could further apply verification and expedite execution time to the Advertisement day proceedings by allowing retail business compliance and increasing consumer confidence in accurately reflected price point purchases. The process of the present invention helps to ensure accurate and rapid assurance that the prices listed on products, shelves, and advertisements are consistent, correct, and identical across all signage and advertisements for each retail store location.

It should be understood that both UPC coding and PLU coding can be incorporated by the present invention. Further, the following nomenclature should be understood as applying to this Specification: Screen Shot (SS); Headquarters (HDQ); Merchandising End Cap Displays (MECD); Sales Planner (SP); File Pricing Clerk (FPC); Numeric Linear Designated Information (NLDI); Business Solutions Software (BSS); Bulletin Merchandising Displays (BMD); Linear Designated Information (LDI).

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

I claim:

1. A method for expediting data entry across multiple fields via a Microsoft Word Textbox (MTB), comprising:
accessing a computer terminal;
wherein the computer terminal is equipped with a user interface device;
wherein the computer terminal is connected to a network and the inventory database of at least one retail store;
opening a business solutions software (BSS) application on the computer terminal;
opening the Microsoft Word Textbox (MTB) within a word processor document;
wherein the Microsoft Word Textbox (MTB) contains a unique numeric sequence;
accessing a sales planner within the business solutions software (BSS) application;
wherein the sales planner has an embedded Product Replication Key (PRK) box assigned to it;
wherein the embedded Product Replication Key (PRK) box is configured to accept data from the Microsoft Word Textbox (MTB) via a clipboard;
a user clicking on the Microsoft Word Textbox (MTB) with the user interface device;
entering data into the Microsoft Word Textbox (MTB);
a Product Replication Key (PRK) is applied to the data;
selecting ‘select all’ with the user interface device to select all of the data;
selecting ‘copy’ to copy data within the Microsoft Word Textbox (MTB);
selecting the business solutions software (BSS) application;
pasting the data into the business solutions software (BSS) application;
the computer terminal populating a series of fields with the data; and
executing the print command to print the data within the business solutions software (BSS) application.
